(19) United States
(12) Patent Application Publication
(10) Pub. No.: US 2011/0176010 A1
(43) Pub. Date: Jul. 21, 2011

(54) MOBILE TERMINAL, ICON MATERIAL MANAGEMENT SYSTEM, AND ICON MATERIAL MANAGEMENT METHOD

(75) Inventors: Yoshiharu Houjou, Tokyo (JP); Kazuhiro Kashio, Tokyo (JP)

(73) Assignee: CASIO COMPUTER CO., LTD., Tokyo (JP)

(21) Appl. No.: 13/006,597

(22) Filed: Jan. 14, 2011

(30) Foreign Application Priority Data
Jan. 20, 2010 (JP) 2010-010399

(51) Int. Cl. H04N 5/225

(52) U.S. Cl. 348/207.1; 348/222.1; 348/E05.024

(57) ABSTRACT

A mobile terminal 100 includes an image capturing unit 110, an image processing unit 111, a control unit 101, and a key input unit 114. The image capturing unit 110 captures an image. The image processing unit continuously drives the image capturing unit and acquires data of a plurality of images. The control unit 101 generates decorative data based on the plurality of image data, the decorative data including image data indicative of an image having only an object common to the plurality of images nontransparent. The key input unit 114 inputs a character from an external operation. The control unit 101 determines whether or not character information associated with decorative information is contained in a text constituted by the character information inputted by the key input unit 114, and substitutes the character information with the decorative data associated therewith if it is determined that the character information is included.

### CROSS REFERENCE TO RELATED APPLICATIONS

This application is based on and claims the benefit of priority from Japanese Patent Application No. 2010-010399, filed on 20 Jan. 2010, the content of which is incorporated herein by reference.

### BACKGROUND OF THE INVENTION

1. Field of the Invention

The present invention relates to a mobile terminal capable of generating a decoration email based on, for example, newly acquired composed icon material, and an icon material management system and method for managing and providing such icon material through a network.

2. Related Art

Conventionally, there is known a technology of attaching decorative information to character information using a descriptive language such as HTML (HyperText Markup Language). Moreover, there exist communication terminals such as mobile phones having a function of sending and receiving an email (also herein referred to as “decoration email”) having character information attached with the decorative information by means of the above technology or the like.

For example, Japanese Patent Application Publication No. 2004-310352 discloses a mobile terminal employing a technology that decorates electronic documents by inserting previously provided GIF (Graphics Interchange Format) image files into the documents to make the display contents attractive when displayed.

On the other hand, Japanese Patent Application Publication No. 2004-201191 discloses a technology of attaching short movie files captured by a built-in camera for the purpose of enhancing the expressive power of electronic documents.

As described in the above, there exist a large number of techniques that provide documents with rich expressiveness, including the insertion of animations. However, animation files available for users to decorate messages are in many cases prepared by service providers in advance.

Inserting GIF animation files prepared in advance within a mobile terminal into a document for decoration is effective in reducing the total size of the document and graphical processing load. However, the above techniques have a problem of going stale after continual usage. Moreover, it is unrealistic for a service provider to keep creating and providing new composed icon material, since it requires a lot of cost and time.

### SUMMARY OF THE INVENTION

The present invention is conceived in view of the above problem, and it is an object of the present invention to enable the creation of decoration email based on newly acquired composed icon material, and to manage such icon material as well as to provide the icon material to users via a network.

In accordance with a first aspect of the present invention, there is provided a mobile terminal, comprising: an image capturing unit that captures an image; an image acquiring unit that continuously drives said image capturing unit and acquires data of a plurality of images; a decorative data generating unit that generates decorative data based on the data of the plurality of images, the decorative data including image data indicative of an image having only an object common to the plurality of images, nontransparent; an associating unit that associates the decorative data generated by the decorative data generating unit with character information; a character input unit that inputs a character from an external operation; a character information determining unit that determines whether or not character information associated with the decorative data is contained in a text constituted by the character inputted by the character input unit; and a substituting unit that substitutes and displays the character information with the decorative data associated therewith, if the character information determining unit determines that the character information is included.

In accordance with a second aspect of the present invention, there is provided an icon material management system comprising: a communication unit that communicates with an external device including the aforementioned mobile terminal; an icon material data storing unit that stores as icon material data decorative data associated with character information; and a control unit; wherein the icon material management system stores the icon material data received from the mobile terminal in the icon material storing unit, and the control unit sends the icon material data stored in the icon material storing unit to the mobile terminal in response to a request from the external device.

In accordance with a third aspect of the present invention, there is provided an icon material management method, comprising: an icon material storing step of storing decorative data associated with the character information received from the aforementioned mobile terminal as icon material data; and an icon material sending step of sending the icon material data stored in the icon material storing step to the mobile terminal in response to a request from an external device.

### BRIEF DESCRIPTION OF THE DRAWINGS

FIG. 1 is a view showing a configuration of a mobile terminal according to a first embodiment of the present invention;

FIG. 2 is a flowchart showing processing carried out when creating a decoration email using a moving image captured by the mobile terminal shown in FIG. 1 as icon material;

FIG. 3 is a diagram illustrating a principle of creating an animation file from images captured by the mobile terminal shown in FIG. 1;

FIG. 4 is a diagram showing an example of a decoration email displayed by the mobile terminal shown in FIG. 1;

FIG. 5 is a diagram illustrating a principle of creating an animation file from images captured by the mobile terminal shown in FIG. 1;

FIG. 6 is a diagram showing a display example of a conversion dictionary including an animation file created by the mobile terminal shown in FIG. 1;

FIG. 7 is a view showing a configuration of an icon material management system according to a second embodiment of the present invention;

FIG. 8 is a diagram showing an example of a data storing format of an icon material database;

FIG. 9A is a diagram showing examples of a data storing format of a user database;

FIG. 9B is a diagram showing examples of a data storing format of a user database;

FIG. 9C is a diagram showing examples of a data storing format of a user database;

FIG. 10A is a diagram illustrating an example of screens displayed when a user uploads icon material;

FIG. 10B is a diagram illustrating an example of screens displayed when a user uploads icon material;

FIG. 11 is a flowchart showing flow of an icon material purchase processing;

FIG. 12A is a diagram showing an example of icon material search screens;

FIG. 12B is a diagram showing an example of icon material search screens;

FIG. 12C is a diagram showing an example of icon material search screens; and

FIG. 13 is a flowchart showing flow of a charge processing.

### DETAILED DESCRIPTION OF THE INVENTION

The following describes embodiments of the present invention with reference to the drawings.

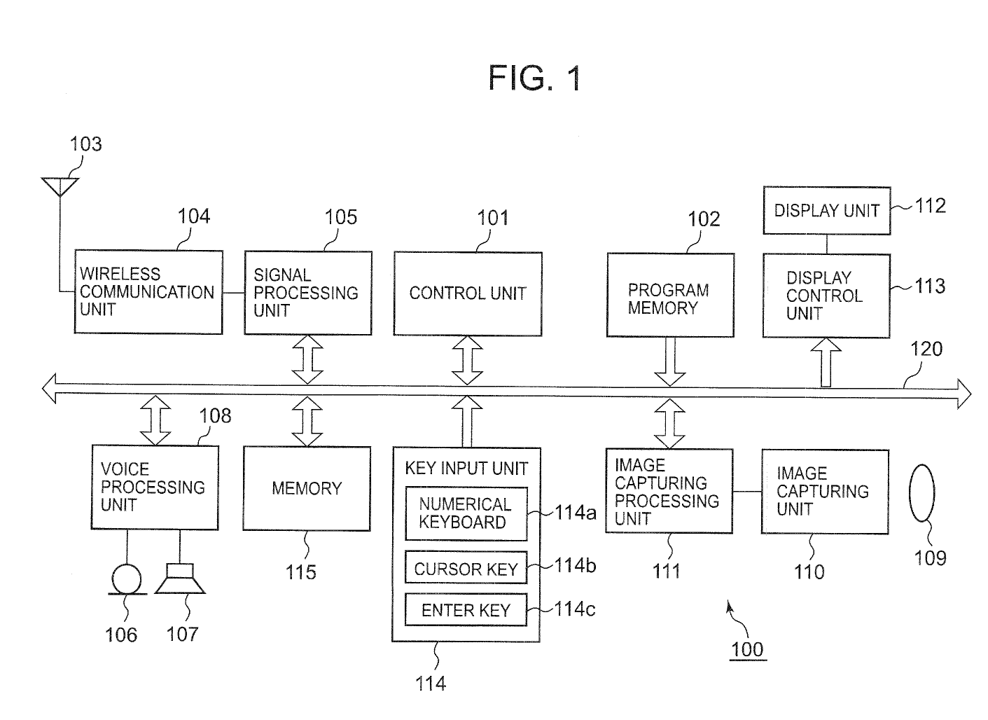

FIG. 1 is a view showing a configuration of a mobile terminal 100 according to a first embodiment of the present invention. As is shown in FIG. 1, the mobile terminal 100 according to the present embodiment is provided with a control unit 101 that controls the whole operation of the mobile terminal 100, a program memory 102 that stores a program executed by the control unit 101 to operate the mobile terminal 100, a signal processing unit 105, a voice processing unit 108, an image capturing processing unit 111, a display control unit 113, a key input unit 114, a memory 115, and a bus 120.

The control unit 101 is constituted by a CPU (Central Processing Unit), for example. The control unit 101 controls the whole operation of the mobile terminal 100 and is electrically interconnected via the bus 120 to each of the program memory 102, the signal processing unit 105, the voice processing unit 108, the image capturing processing unit 111, the display control unit 113, the key input unit 114, and the memory 115. The program memory 102 stores programs executable by the control unit 101 to operate the mobile terminal 100. The control unit 101 executes the programs stored in the program memory 102. As is described later in detail, the control unit 101 functions as a decorative data creation unit, an associating unit, a character information determining unit, and a substituting unit.

The wireless communication unit 104 is controlled by the signal processing unit 105 and sends and receives wireless signals via the antenna 103, and performs primary modulation/demodulation according to a predetermined wireless modulation/demodulation method such as the CDMA method. The signal processing unit 105 modulates data inputted from the bus 120 by the QPSK (Quadrature Phase-Shifting Keying) method under the control of the control unit 101, and outputs the thus modulated data to the wireless communication unit 104. The data inputted from the bus 120 may include digital voice data encoded by the CELP (Code-Excited Linear Prediction) method, email data, animation GIF files, and moving image files, for example. Furthermore, the signal processing unit 105 demodulates data inputted from the wireless communication unit 104 and outputs the thus demodulated date to the bus 120. The voice processing unit 108 performs CELP encoding on voice signals inputted from a microphone 106 and outputs the encoded data to the bus 120. Also, the voice processing unit 108 decodes CELP encoded data inputted from the bus 120 into voice signals and outputs the thus decoded voice signals from the speaker 107. The wireless communication unit 104 constitutes a communication unit.

The image capturing unit 110 includes an image capturing device provided with a CMOS (Complementary Metal Oxide Semiconductor) or a CCD (Charge Coupled Device), a DSP (Digital Signal Processor), and the like. The image capturing unit 110 performed digital processing on data of an image formed by an image capturing lens 109. The image capturing unit 110 constitutes an image capturing device that captures images. The image capturing processing unit 111 executes driving control of the image capturing device of the image capturing unit 110 or continuous read out processing related to continuous image capturing, and also outputs the digitalized image data to the bus 120. The display unit 112 displays various data (email data, animation GIF data, moving image data, and the like) via the display control unit 113 under the control of the control unit 101. This means that the image capturing processing unit 111 acquires a plurality of image data by continuously driving the image capturing means.

The key input unit 114 of the operating unit includes a numerical keyboard 114a that detects inputs of alphanumerical characters as well as indicating telephone numbers, cursor keys 114b that cause a cursor to be moved, an enter key 114c that detects the current position of the cursor in an email creating mode, which will be described later, and the like. The key input unit 114 constitutes a character input unit.

The memory 115 is used as an application heap, i.e. a memory used when the control unit 101 executes various programs stored in the program memory 102. In addition, the memory 115 stores various character information used when creating emails, still image files acquired by image capturing, moving image files, animation files, and various downloaded data. Also, the memory 115 stores dictionary information for a conversion dictionary function according to the present embodiment, which will be described later.

### <Decoration Email Creating Processing>

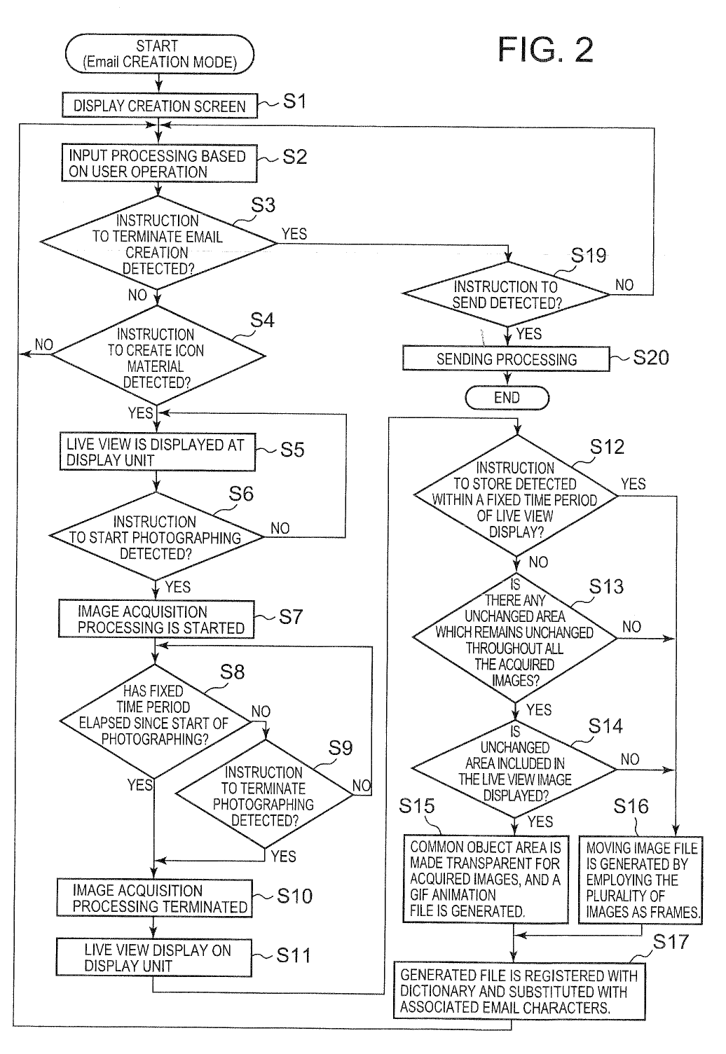

FIG. 2 is a flowchart showing processing carried out by the mobile terminal 100 of a user when creating a decoration email after animation files acquired as a result of the continuous image capturing processing are registered with a conversion dictionary function as icon material for decoration.

When the power-on status is detected, the mobile terminal 100 reads out and executes a program stored in the program memory 102. The mobile terminal 100 executes negotiation processing and communication processing with a remote wireless communication network. When the email creation mode is started as a result of the user's operation of the key input unit 114, the control unit 101 reads out a program stored in the program memory 102 regarding creation of emails of hypertext format, executes the program, and displays an email creation screen on the display unit 112 (step S1).

The control unit 101 detects the user's operation of the numerical keyboard 114a, the cursor keys 114b, the enter key 114c, and the like, executes the input processing of an electronic document that constitutes an email, and creates the email (step S2). Then, the control unit 101 determines whether or not an instruction to terminate the email creation processing is detected (step S3).

Since the email created by the present processing has a hypertext format, the user can not only input characters but also arbitrarily edit the email using HTML tags such as of text color, background color, font size, scrolling text, blinking text, layout, or the like.

When an instruction to terminate the email creation processing is detected in step S3, the control unit 101 determines in step S19 whether or not the control unit 101 detects an instruction to send the created email. On the other hand, if an instruction to terminate the email creation processing is not detected in step S3, the control unit 101 determines whether or not an instruction to create icon material for decoration of the document is detected as a result of operation of the key input unit 114 (step S4).

If an instruction to create icon material is not detected, the control unit 101 returns the processing to step S2. When, on the other hand, an instruction to create icon material is detected, the control unit 101 reads and executes a program for image capturing processing, image processing, and the like, stored in the program memory 102, and activates the image capturing unit 110 and the image capturing processing unit 111. Subsequently, the control unit 101 temporarily stores the contents of the email (electronic document) so far inputted and created in the memory 115. Then, the control unit 101 controls the image capturing processing unit 111 to drive the image capturing unit 110 to periodically capture images and controls the display control unit 113 to cause the display unit 112 to display a live view of images captured and outputted in series from the image capturing unit 110 (step S5).

While the live view is displayed, the control unit 101 determines whether or not an instruction to start photographing is detected, by determining whether or not input by the enter key 114c has been detected (step S6).

If the instruction to start photographing is not detected, the control goes back to step S5. When, on the other hand, the instruction to start photographing is detected, the control unit 101 controls the image capturing unit 110 and the image capturing processing unit 111 to acquire captured images in series and thus start the image acquisition processing for a fixed time period (step S7). Here, the fixed time period may be, for example, a time period required for the total size of the captured images to reach the maximum size of a moving image file attachable to an email. The control unit 101 determines whether or not the fixed time period has elapsed (step S8). If the fixed time period has not elapsed, the control unit 101 determines whether or not an instruction to terminate photographing has been detected from the enter key 114c operated by the user (step S9).

In step S9, if the instruction to terminate photographing is not detected, the control unit 101 returns the process to step S8, and determines whether or not the fixed time period has elapsed. In step S9, if the instruction to terminate photographing is detected, the control unit 101 controls the image capturing unit 110 and the image capturing processing unit 111 and causes termination of the image acquiring processing (step S10). Further, the control unit 101 periodically drives the image capturing unit 110 and causes the display unit 112 to display a live view of images captured and outputted in series from the image capturing unit 110 (step S11).

When the user's operation of the enter key 114c is detected within the fixed time period since the live view display has been started in step S11, the control unit 101 determines whether or not an instruction to store the plurality of images acquired in steps S7 to S10 is detected (step S12). More specifically, the control unit 101 determines whether or not an instruction to store the plurality of images as a moving image file having a plurality of frames respectively constituted by the plurality of images has been inputted from the user.

In step S12, if the instruction to store from the user is detected, the control unit 101 determines that the user wishes to store the plurality of acquired images as a moving image file and the control proceeds to step S16. On the other hand, if the instruction to store is not detected within the fixed time period, the control unit 101 uses an image of the live view, hereinafter simply referred to as “live view image”, currently displayed as an image for detecting areas of difference from among the plurality of images thus acquired.

Therefore, even if the instruction to store is not detected within the fixed time period in step S12, the control unit 101 further determines whether or not there is any unchanged partial area which remains unchanged throughout all of the plurality of the acquired images (step S13).

If it is determined in step S13 that there is no unchanged partial area which remains unchanged throughout all of the plurality of the acquired images, control proceeds to step S16, since it is impossible to detect any area of difference from among the plurality of the acquired images. On the other hand, if it is determined that there is an unchanged partial area which remains unchanged throughout all of the plurality of the acquired images, the control unit 101 determines whether or not the unchanged partial area is included in the live view image currently displayed, since it is possible to detect an area of difference from among the plurality of the acquired images (step S14).

In step S14, if it is determined that the unchanged partial area which remains unchanged throughout all of the plurality of the acquired images is not included in the live view image currently displayed, the control proceeds to step S16, since it is impossible to find a reference area to be used to detect an area of difference from the live view image. On the other hand, if it is determined that the unchanged partial area which remains unchanged throughout all of the plurality of the acquired images is included in the live view image currently displayed, the control unit 101 generates a GIF animation file in which the unchanged partial area (common object area) is made transparent (step S15), since it is possible to find a reference area to be used to detect a difference area from the live view image.

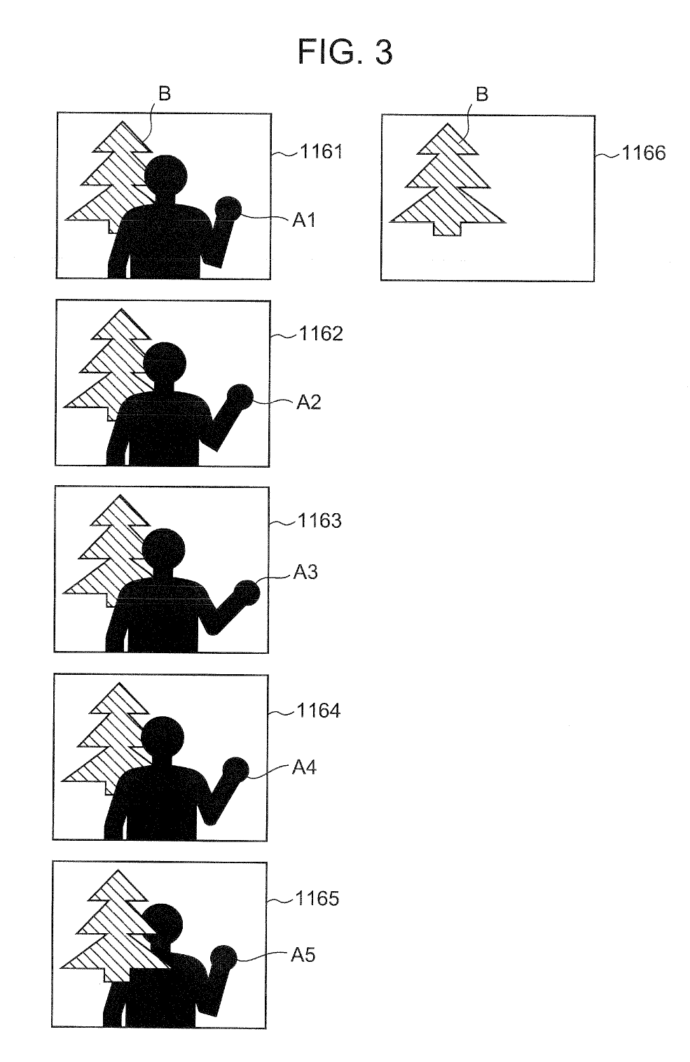

FIG. 3 is a diagram illustrating a principle of creating an animation file in step S15. In FIG. 3, it is assumed that there are five images 1161 to 1165 acquired in steps S7 to S10. The images 1161 to 1165 have object image areas A1 to A5 respectively and have an object image area B in common.

The image 1166 remains displayed as a live view for the fixed time period from when the live views are displayed in step S11. If the instruction to store is not detected within the fixed time period, the control unit 101 determines in step S13 that there is an unchanged partial area which remains unchanged throughout the images 1161 to 1165. The control unit 101 carries out transparent processing on pixels which are located outside of the object image areas A1 to A5 by setting the alpha value of 0 (α=0) to those pixels. In contrast to this, the control unit 101 carries out non-transparent processing on only pixels which are located in the object image area A1 for the image 1161, in the object image area A2 for the image 1162, in the object image area A3 for the image 1163, in the object image area A4 for the image 1164, and in the object image area A5 for the image 1165 the pixels by setting the alpha value to 1 (α=1) to those pixels. Then, the control unit 101 generates a five-frame GIF animation file having the object image areas A1 to A5 as objects in common.

When an animation file is generated in step S15, the control unit 101 reads the email data temporarily stored in the memory 115 and controls the display control unit 113 to display the email to the display unit 112.

The animation file generated in step S15 or the moving image file generated in step S16 is registered as dictionary information of the conversion dictionary function in the memory 115 in association with characters to be converted (for example, Japanese HIRAGANA characters) by way of dictionary registration processing executed by the user's arbitrary operation. The generated animation file or the moving image file is substituted with associated characters in accordance with a program of editing emails of hypertext format (step S17). The animation files thus generated constitute decorative data or icon material according to the present invention.

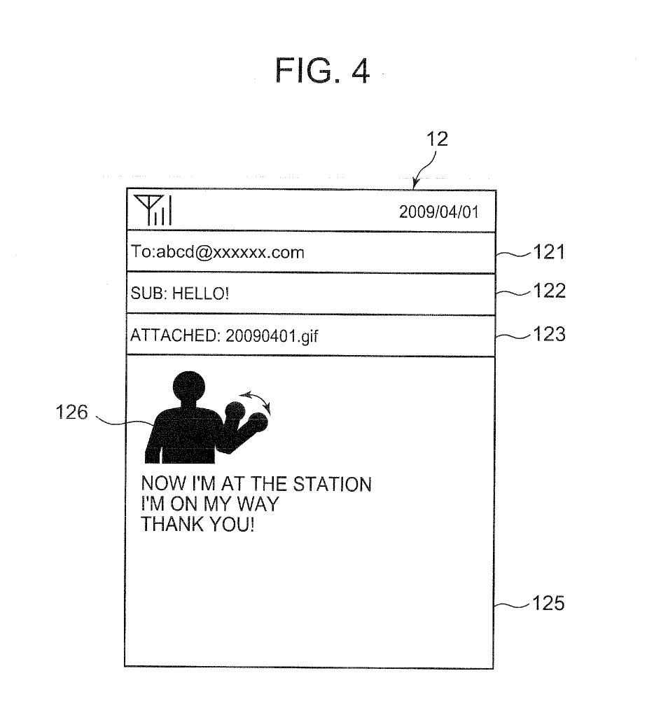

FIG. 4 is a diagram showing a display example of a decoration email generated by employing an animation file created in step S15.

In FIG. 4, the destination address of the email is displayed at 121, the subject of the email, “Hello”, is displayed at 122, the filename of the file (animation file) attached to the email is displayed at 123, and contents 126 of the animation file are displayed along with the email text 125 at the position where the characters “Hello” are located as an animation GIF icon.

On the other hand, when control proceeds to step S16, a moving image file is generated by employing the plurality of images acquired in steps S7 to S10 as frames thereof.

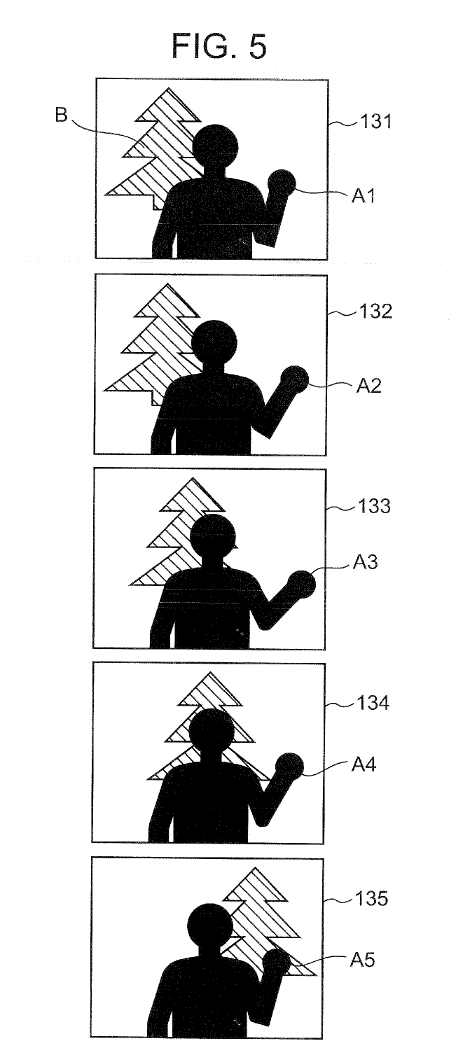

FIG. 5 is a diagram illustrating a principle of creating an animation file in the case in which control proceeds from step S13 to step S16. In FIG. 5, it is assumed that there are five images 131 to 135 acquired in steps S7 to S10. The images 131 to 135 have object image areas A1 to A5 respectively and have an object image area B in common.

Then, the control unit 101 determines in step S13 that the whole image area is changing through all of the plurality of acquired images, and accordingly, there is no unchanged partial area which remains unchanged throughout all of the plurality of the acquired images, since the position of the object image B changes in the images 131 to 135. Therefore, control proceeds to step S16, and the control unit 101 creates a moving image file encoded according to, for example, MPEG-4 format, using the images 131 to 135 as frames of the moving image file.

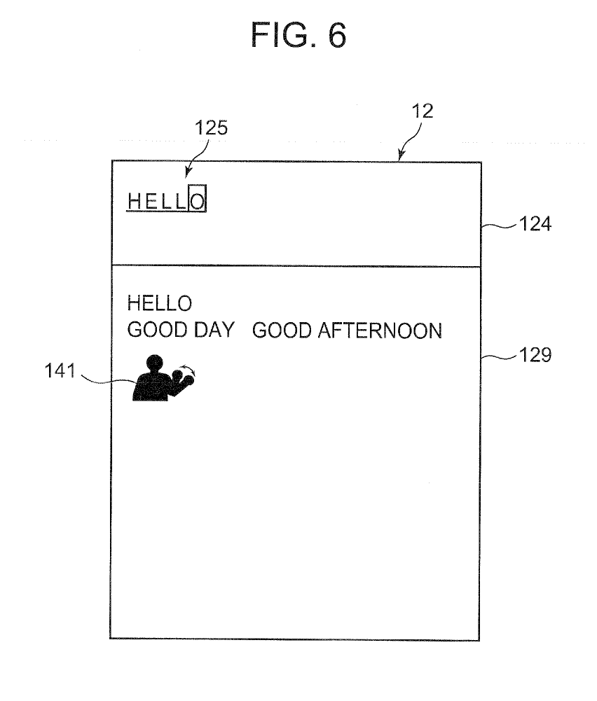

FIG. 6 is a diagram showing a display example of a conversion dictionary including an animation file generated in step S15. Here, the animation file created in step S15 is registered with the conversion dictionary in association with the character information “Hello”.

In FIG. 6, when the user inputs “Hello” in the email text and activates the conversion dictionary function, the animation GIF icon associated with the moving image file 141 cutout and created in step S15 is displayed as a conversion candidate along with other conversion candidates on the screen 129. If the language is Japanese, the conversion candidates may include, for example, Kanji and Kana characters.

After the character “Hello” is substituted by the animation GIF icon in step S17, control goes back to step S2. If, on the other hand, the instruction to terminate the email creation processing is detected in step S3, the control unit 101 further determines whether or not the instruction to send is detected or not (step S19).

If the instruction to send is not detected, control goes back to step S2. If, on the other hand, the instruction to send is detected, control unit 101 controls the antenna 103, the wireless communication unit 104, and the signal processing unit 105 to send the email text (along with attached files, if any) to the designated destination address (step S20), and the process ends.

As will be understood from the foregoing description, the mobile terminal according to the present embodiment, from among a plurality of images captured by an image capturing device mounted on the mobile terminal, generates decorative data as icon material, and associates the icon material with character information by using the conversion dictionary function. Since an email, i.e. a decoration email can be created by substituting the associated character information with the decorative data, it is possible to generate a decoration email always with new icon material.

According to the present embodiment, if the instruction to create icon material is detected in step S4 while creating a decoration email, the control unit 101 drives the image capturing processing unit 111 to create moving images, and then create an animation file as decorative data or icon material. Furthermore, the control unit 101 registers the decorative data or animation file with the dictionary in the memory 115 and substitutes the decorative data or animation file for a character of an email. However, although the present embodiment has been described as above, the present invention is not limited thereto. For example, the user can input the instruction to create icon material not only when creating a decoration email but at any time by operating the key input unit 114. More specifically, the process of steps S4 to S17 can be executed as dictionary registration processing independent of the email creation processing. Also, while it has been described in the above that the animation file created in step S15 or step S16 is substituted for a corresponding character in the email currently being created after the animation file is registered with the memory 115 as dictionary information associated with the corresponding character by the conversion dictionary function in step S17. However, the animation file need not be substituted for any character of the email currently being created, but only be registered with the dictionary information of the conversion dictionary function in the memory 115 in association with a character by the user's operation of the key input unit 114. Furthermore, the user may only substitute the animation file for a character of the email currently being created.

In the present embodiment, a description has been given of a case in which a stand-alone mobile terminal equipped with an image capturing device generates icon material, registers the icon material with a conversion dictionary function, and generates a decoration email. However, the present invention is not limited thereto, and various modifications are possible. For example, it is possible that the mobile terminal communicates with a server via a wireless communication network or the like to send and receive the icon material. Such a configuration will be described in the next embodiment.

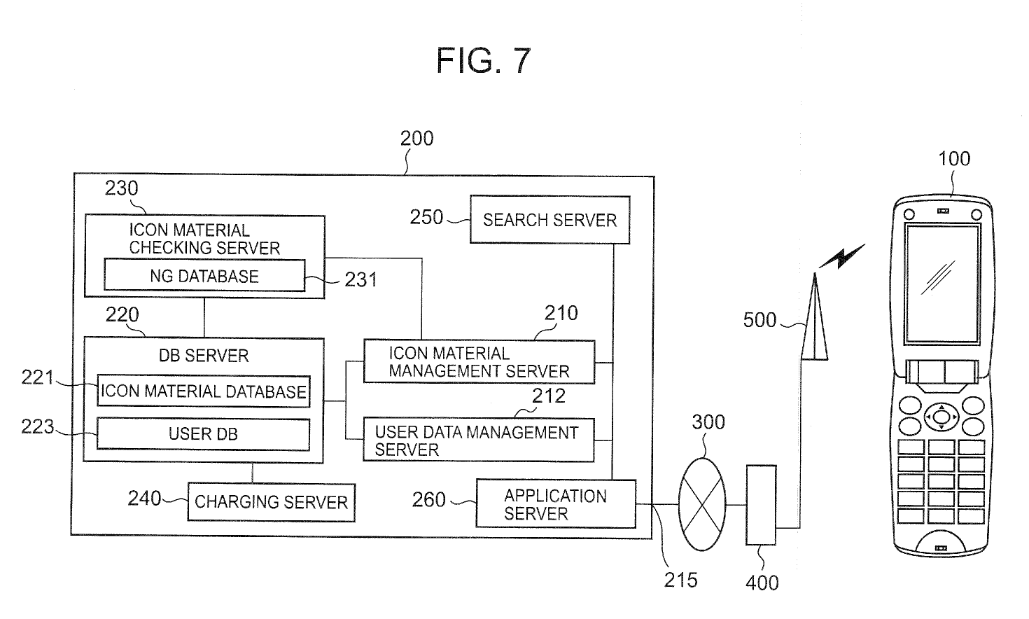

FIG. 7 shows an example of a configuration of the icon material management system 200 according to a second embodiment of the present invention. As shown in FIG. 7, the icon material management system 200 includes, an icon material management server 210, a user data management server 212, a DB (Data Base) server 220, an icon material checking server 230, a fee charging server 240, a search server 250, and an application server 260. In the icon material management system 200, the icon material checking server 230 and the application server 260 are connected with and can send data to and receive data from the mobile terminal 100 via a communication interface 215, a communication network 300, a wireless communication service provider 400, and a wireless base station 500. The communication network 300 includes communication networks such as, for example, a WAN (Wide Area Network) or the Internet. The communication interface 215 constitutes a communication unit of the icon material management system 200. In the present embodiment, the mobile terminal 100 operated by a user generates decorative data from among a plurality of images captured by the image capturing device mounted thereon and sends the generated decorative data as icon material to the icon material management system 200. The configuration elements the same as those of the first embodiment bear the same reference numbers as those of the first embodiment and explanation thereof is omitted.

As shown in FIG. 7, the icon material management server 210, the user data management server 212, the DB server 220, the icon material checking server 230, the fee charging server 240, the search server 250, and the application server 260 are connected with each other via a network such as a LAN so as to be able to send data to and receive data from each other.

Each of the icon material management server 210, the user data management server 212, the DB server 220, the icon material checking server 230, the fee charging server 240, the search server 250, the application server 260, and the mobile terminal 100 of a user are not shown, but are configured from a CPU, a memory unit, RAM (Random Access Memory), an input unit that inputs a user's instructions and data, a display unit that displays information, a communication unit that sends and receives data, and the like. The CPU executes various functions, which will be described later, in cooperation with programs stored in the memory unit.

The icon material management server 210 stores and manages, from among the icon material sent from the mobile terminal 100, those checked via the icon material checking server 230. The icon material management server 210 manages, in addition to icon material sent from the mobile terminal 100, data to be sold to users. The data to be sold to users may include, for example, GIF object files created by service providers or individual creators as authors using, for example, 3DCG (3-Dimensional Computer Graphics). Icon material created by creators may be uploaded to the icon material management server 210 via various communication means other than the mobile terminal 100 such as direct delivery of media (e.g. CD-ROM) containing the above mentioned object files, or wired communication lines. The icon material management server 210 constitutes an icon material storing unit of the icon material management system 200.

The user data management server 212 stores and manages personally posted icon material uploaded by users via the application server 260 as well as posters' personal information such as name and credit card information.

The DB server 220 includes an icon material database (hereinafter referred to as “icon material DB”) 221 and a user database (hereinafter referred to as “user DB”) 223. The DB server 220 stores and manages information such as image data and various user information as a database. The icon material management server 210 creates, stores, and manages a duplicate copy of the contents of the icon material DB 221. The user data management server 212 creates, stores, and manages the duplicate copy of the contents of the user DB 223.

The icon material management server 210 and the user data management server 212 are periodically synchronized with the DB server 220 so as to share the same contents. The icon material management server 210 and the user data management server 212 may be synchronized with the DB server 220, for example, at fixed intervals or at the time when a personally posted icon material is uploaded from the terminal 100 of a user.

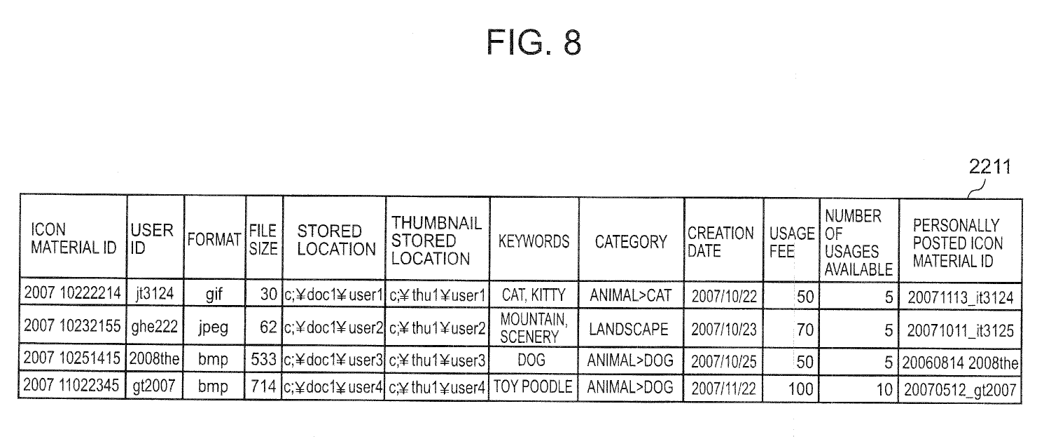

FIG. 8 shows an example of a data storing format of the icon material DB 221. As shown in FIG. 8, the icon material DB 221 is a database for storing information on uploaded icon material. The icon material DB 221 includes an icon material DB main table 2211. The icon material DB main table 2211 has fields of “icon material ID”, “user ID”, “format”, “file size”, “storage location”, “thumbnail storage location”, “keywords”, “category”, “creation date”, “usage fee”, “number of usages available”, and “personally posted icon material ID”.

The “icon material ID” field stores icon material ID uniquely assigned to uploaded icon material. The “user ID” field stores information on a user ID uniquely assigned to a poster, i.e. a user who posted the icon material. The “format” field stores information on data format of the icon material. The “file size” field stores information on file size of the icon material. The “storage location” field stores information on a directory in which the icon material is stored. The “thumbnail storage location” field stores information on a directory in which a thumbnail of the icon material is stored. The “keywords” field stores information on one or more keywords used when a user searches for the icon material in need. The “category” field stores information on a category to which the icon material belongs. The “creation date” field stores information on the date when the icon material was created. The “usage fee” field stores information on usage fee for the icon material. The “number of usages available” field stores information on the maximum number of times the icon material can be used. The “personally posted icon material ID” field stores information on personally posted icon material ID if the icon material is personally posted icon material. If the icon material is not personally posted icon material, NULL is stored in the “personally posted icon material ID” field. In this case, the icon material may be provided by, for example, the service provider.

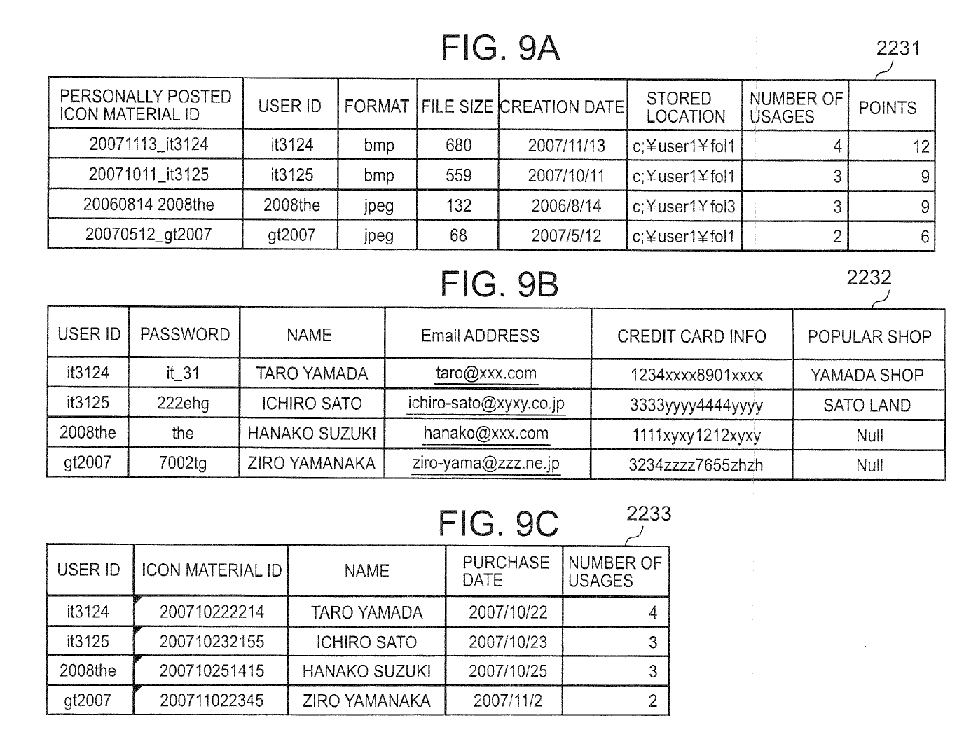

FIG. 9 shows examples of a data storing format of the user DB 223. The user DB 223 stores information on users. As shown in FIG. 9, the user DB 223 includes a personally posted icon material table 2231, a personal information table 2232, and a purchased icon material table 2233.

The personally posted icon material table 2231 stores information on personally posted icon material such as above mentioned animation files uploaded by users. As shown in FIG. 9A, the personally posted icon material table 2231 may have fields of “personally posted icon material ID”, “user ID”, “format”, “file size”, “creation date”, “storage location”, “number of usages”, and “points”.

The “personally posted icon material ID” field stores information on a personally posted icon material ID uniquely assigned to personally posted icon material. The “user ID” field stores information on a user ID of a user who posted the personally posted icon material. The “format” field stores information on data format of the personally posted icon material. The “file size” field stores information on file size or data size of the personally posted icon material. The “creation date” field stores information on the date when the personally posted icon material was created. The “storage location” field stores information on a location where the personally posted icon material is stored. The “number of usages” field stores information on the number of times the personally posted icon material was used. The “points” field stores information on points given to the user each time icon material personally posted by the user is used.

The personal information table 2232 stores personal information of users. As shown in FIG. 9B, the personal information table 2232 may have fields of “user ID”, “password”, “name”, “email address”, “credit card info”, and “popular shop”.

The “user ID” field stores user ID information of a user. The “password” field stores information on a password set for the user. The “name” field stores information on the name of the user. The “email address” field stores information on an email address of the user. The “credit card info” field stores information on a credit card of the user. A user who has posted frequently used icon material may have a special site, which will be described later in detail, where icon material posted by the user can be separately searched for. The “popular shop” field stores a name of the special site. For a user who does not have a special site, NULL is stored in the “popular shop” field.

The purchased icon material table 2233 stores information on icon material purchased by users. As shown in FIG. 9C, the purchased icon material table 2233 has fields of “user ID”, “icon material ID”, “name”, “purchase date”, and “number of usages”.

The “user ID” field stores information on a user ID of a user who purchased icon material. The “icon material ID” field stores information on an icon material ID of the icon material purchased by the user. The “purchase date” field stores information on a date when the icon material was purchased. The “number of usages” field stores information on the remaining number of usages available for the icon material purchased by the user.

When uploading icon material data, the mobile terminal 100 connects with the icon material checking server 230. The icon material checking server 230 sends to the mobile terminal 100 a request to agree with copyright rules and a request to send icon material data. The icon material checking server 230 also has an NG word database 231 that stores inappropriate (not good) words. Here, “NG word” designates a word highly likely to be an illegal duplication or to be offensive to public order and morals. The icon material checking server 230 checks whether or not icon material to be uploaded by a user is an illegal duplication or offensive to public order and morals, with reference to NG words stored in the NG word database 231. Furthermore, the icon material checking server 230 may include a copyright information database which collects publicly known copyrighted works, perform an image recognition processing on an image of uploaded icon material data, and check whether or not the icon material violates copyright with reference to the copyright information database. The icon material checking server 230 constitutes an icon material checking unit of the icon material management system 200.

The description hereinafter is directed to flow of input operations when a user uploads icon material data to the icon material DB 221 with reference to the drawings.

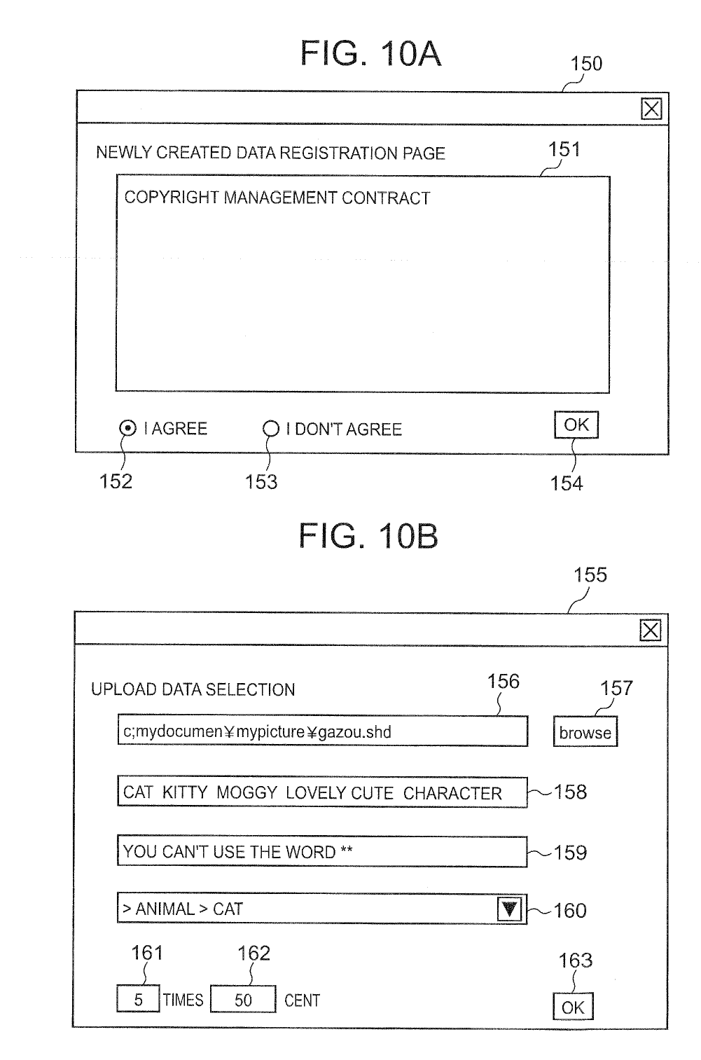

FIG. 10A shows a copyright management contract screen 150 displayed on the mobile terminal 100 of a user when the user uploads icon material data. The copyright management contract screen 150 includes a region 151 that displays text for a copyright management contract, radio buttons 152 and 153, an “OK” button 154, and the like. The copyright management contract screen 150 is displayed after the mobile terminal 100 of the user is connected with the icon material checking server 230, the user's input of a genuine user ID and password is accepted on the login screen (not shown) sent from the icon material checking server 230, and the user's login to the icon material checking server 230 is complete.

The user ID and password inputted at this time are certified after being checked with the personal information table 2232 stored in the user data management server 212 via the icon material checking server 230. In the present embodiment, those who possess user IDs can log in as creators who upload icon material of his or her own creation for donation or for sale and also can log in as users who purchase icon material of others for use. Specifically, any user can use the icon material management system 200 as a creator if his or her mobile terminal 100 is connected with the icon material checking server 230, and as a user if his or her mobile terminal 100 is connected with the application server 260. Furthermore, a user may input a user ID other than the user ID used as a user, if the user uses the icon material management system 200 as a creator. For convenience of explanation, a user who uploads icon material to the icon material management system 200 for sale is hereinafter referred to as “creator”.

If the radio button 152 “I agree” is selected and the “OK” button 154 is clicked as a result of the creator's operation on the copyright management contract screen 150, the screen changes to the upload data selection screen 155, which will be described later. If, on the other hand, the radio button 153 “I don't agree” is selected and the “OK” button 154 is clicked, the screen is terminated, since the creator doesn't agree with the copyright management contract.

FIG. 10B shows an upload data selection screen 155 displayed when the creator uploads icon material data. The upload data selection screen 155 includes an “upload data selection” tag 156, a “browse” button 157, a “keywords” tag 158, an “NG notification” tag 159, a “category selection” tag 160, a “number of usages” tag 161, a “usage fee” tag 162, and an “OK” button 163, and the like.

If the “browse” button 157 is clicked and a file, in which image data to be uploaded is stored, is selected as a result of the creator's operation on the upload data selection screen 155, icon material to be uploaded is designated in the “upload data selection” tag 156. Then, one or more keywords are entered by the creator's operation into the “keywords” tag 158. At this time, in a case in which an inappropriate (NG) word is included in the entered keywords, a message “You can't use the word **” is displayed in the “NG notification” tag 159, and no further operation can be performed unless the creator enters another keyword. Furthermore, in a case in which a copyright information database is provided, the icon material to be uploaded is checked with reference to the copyright information database, and in a case in which there is a likelihood of violating copyright, a message “You can't upload this icon material” is displayed in the “NG notification” tag 159, and no further operation can be performed unless the creator designates other icon material.

At the “category selection” tag 160, a category related to the icon material is selected. In the example of the upload data selection screen 155, any input can be arbitrarily entered in the “keywords” tag 158, while in the “category selection” tag 160 an input is selected only from a pull down menu. However, input formats are not limited to the present embodiment. For example, the “category selection” tag 160 may allow any input to be arbitrarily entered, or any input formats are applicable to each of the tags in accordance with the actual implementation. Furthermore, in order to upload icon material so as to be used as dictionary information of the conversion dictionary function as described with reference to FIG. 4, a user may input character information to be converted corresponding to the icon material in the “keywords” tag 158, and select “dictionary function” at the “category selection” tag 160.

Then, the number of usages of the icon material is entered in the “number of usages” tag 161, and a usage fee is entered in the “usage fee” tag 162, by the creator's operation. In the example of FIG. 10B, a user may use the icon material for 5 times at a cost of 50 cent. If a creator wishes to donate the icon material, the creator may enter 0 in the “usage fee” tag 162.

If the “OK” button 163 is clicked, the input data is uploaded via the icon material checking server 230 to the icon material management server 210 and stored in the icon material DB main table 2211. Specifically, the icon material management server 210 assigns a unique icon material ID to the uploaded icon material and a thumbnail thereof is created. The icon material and the thumbnail thereof are stored in a directory specified in advance by the icon material management server 210. The icon material management server 210 stores the icon material ID in the “icon material ID” field, the user ID of the creator who uploaded the icon material in the “user ID” field, the icon material's data format in the “data format” field, the icon material's file size in the “file size” field, the folder in which the icon material is stored is in the “storage location” field, the folder in which the thumbnail is stored is in the “thumbnail storage location” field, the entered one or more keywords in the “keywords” field, the selected category in the “category” field, the usage fee entered in the uploaded data selection screen 155 in the “usage fee” field, and the number of usages entered in the uploaded data selection screen 155 in the “number of usages available” field, respectively, as new data in the icon material DB 221.

The upload of the icon material is completed as a result of the operation described in the above.

The fee charging server 240 adds up usage fees of icon material purchased by users and charges the users the fee.

The search server 250 searches for icon material stored in the icon material management server 210.

The application server 260 provides the mobile terminal 100 of a user with an application required to utilize services of various kinds, executes processing in response to an input from the mobile terminal 100 of the user, and sends input information received from the mobile terminal 100 of the user to the icon material management server 210, the user data management server 212, and the search server 250. The application server 260 constitutes the control unit of the icon material management system 200.

The following describes main operations carried out by the icon material managing system 200 according to the present embodiment to provide icon material and charge for the icon material in details with reference to flowcharts.

### <Icon Material Purchasing Processing>

In the icon material management system 200, icon material is provided by icon material purchasing processing initiated by the mobile terminal 100 of a user.

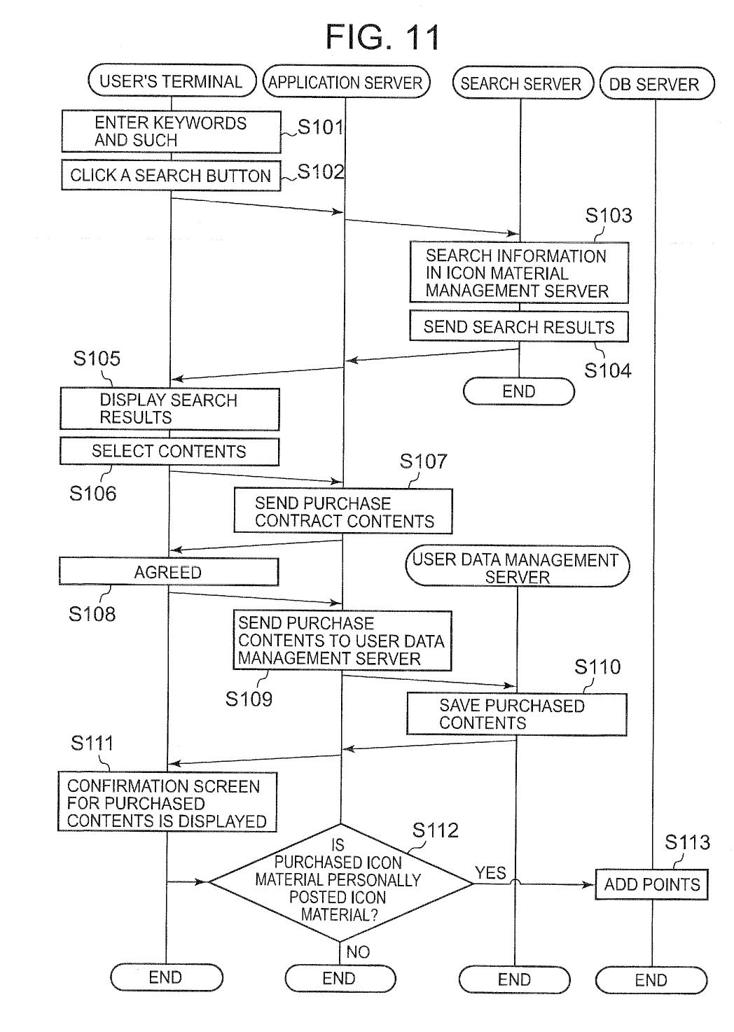

FIG. 11 shows flow of the icon material purchasing processing executed by the user data management server 212, the search server 250, the application server 260, and the mobile terminal 100 of a user when an instruction to purchase icon material is entered from the mobile terminal 100 of the user.

The icon material purchasing processing is processing for purchasing icon material stored in the icon material management server 210. As a precondition for the processing, it is assumed that the user has sent the user ID and password entered from the mobile terminal 100 on the login screen (not shown) to the application server 260 and has been authenticated by the user data management server 212.

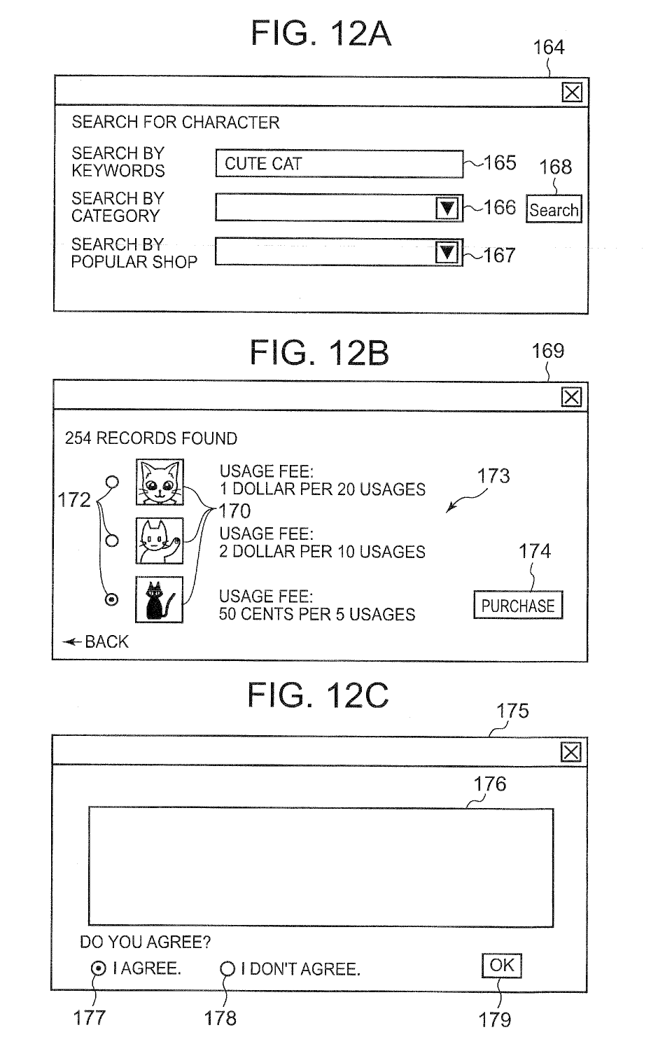

After the user is authenticated by the user data management server 212, an operation screen for searching for icon material is displayed on the display unit of the mobile terminal 100 of the user, and the screen waits for input such as keyword and category from the mobile terminal 100 of the user (step S101). FIG. 12A shows an icon material search screen 164 as an example of the operation screen to search for icon material. The icon material search screen 164 includes a keyword input tag 165, a category selection tag 166, a popular shop selection tag 167, a “search” button 168, and the like.

With reference to the number of usages in the personally posted icon material table 2231 of the user DB 223, users who posted frequently used icon material are privileged to be separately searched for by another key named “popular shop”. Specifically, the number of usages is added up for each user ID, users who posted frequently used icon material are identified, and search key “popular shop” is separately assigned to the users. As a name of the “popular shop” key, the name stored in the “popular shop” field of the personal information table 2232 of the user DB 223 may be used.

Keywords are entered in the keyword input tag 165 and/or a category is selected in the category selection tag 166 and/or a popular shop is selected in the popular shop selection tag 167, and then, the “search” button 168 is clicked by the user operating the mobile terminal 100 (step S102), the entered keywords and/or the selected category and/or the selected popular shop are sent to the search server 250 via the application server 260. In step S102, the user is requested to designate at least one of the search keys, “keywords”, “category”, and “popular shop”. Here, in the case in which “dictionary function” is entered in the category selection tag 160, icon material for dictionary information associated with the entered keyword as character information is searched. The search server 250 searches information stored in the icon material DB main table 2211 of the icon material management server 210 using the keywords and/or the category and/or the popular shop sent from the mobile terminal 100 of the user as search conditions (step S103).

The search processing in step S103 may be executed by either perfect matching or partial matching between each keyword and information stored in the “keywords” field of the icon material DB main table 2211 contained in the icon material management server 210. If a category (or popular shop) is entered, the search can be executed by perfect matching with information stored in the “category” field (or the “popular shop” field).

When the search server 250 extracts searched results acquired in step S103, the searched results are sent to the mobile terminal of the user via the application server 260 (step S104). The mobile terminal of the user displays a screen showing the search results based of the received search results (step S105).

FIG. 12B shows a search result screen 169 as an example of a screen showing search results displayed in step S105. The search result screen 169 includes thumbnails 170, a radio button group 172, a usage fee information display area 173, and a “purchase” button 174. In the case in which a plurality of items of icon material are matched with the search conditions, icon material is displayed in a latest-to-oldest order with reference to the “creation date” field stored in the icon material DB main table 2211.

When a radio button of the radio button group 172 displayed in the search result screen 169 is checked and the “purchase” button 174 is clicked by the user operating the mobile terminal 100, the icon material ID of the icon material checked in the radio button group 172 is sent as the icon material ID of the icon material to be purchased to the application server 260 (step S106).

When the icon material ID of the icon material to be purchased is entered and sent from the mobile terminal 100 of the user to the application server 260 in step S106, the application server 260 sends back purchase rules contents to the mobile terminal 100 of the user (step S107) and a purchase rules screen 175 is displayed on the mobile terminal 100 of the user.

FIG. 12C shows the purchase rules screen 175 as an example of an operation screen displayed based on purchase rules contents sent from the application server 260. The purchase rules screen 175 includes a text 176 explaining purchase rules, radio buttons 177 and 178, and an “OK” button 179, and the like.

After the purchase rules screen 175 is displayed on the mobile terminal 100 of the user, when the radio button 177 “I agree” is selected and the “OK” button 179 is clicked by the user operating the mobile terminal 100, acknowledgement of agreement with the purchase rules is sent to the application server 260 (step S108). When the radio button 178 “I don't agree” is selected and the “OK” button 179 is clicked, the process is terminated.

When the application server 260 receives the acknowledgement of agreement with the purchase rules from the mobile terminal 100 of the user, the icon material ID sent from the mobile terminal 100 of the user and the user's user ID are sent to the user data management server 212 (step S109). The user data management server 212 stores the purchase contents of the user in the purchased icon material table 2233 contained in the user data management server 212 (step S110). Specifically, the received user ID is stored in the “user ID” field, the received icon material ID is stored in the “icon material ID” field, the date when the icon material purchase processing has been carried out is stored in the “purchase date” field, and the number of usages available stored in the “the number of usages available” field of the data corresponding to the icon material ID of the icon material DB main table 2211 is stored in the “number of usages” field of the purchased icon material table 2233 as new data.

After the registration with the purchased icon material table 2233 is complete, the user data management server 212 sends a confirmation screen (not shown) of the received purchase contents to the mobile terminal 100 of the user via the application server 260. The confirmation screen is displayed on the mobile terminal 100 of the user based on the confirmation information of the received purchase contents (step S111), and the process of the mobile terminal 100 is terminated. In the case in which “dictionary function” has been designated in the “category selection” tag 166 in step S101, the icon material thus purchased and downloaded is registered with the dictionary information of the conversion dictionary function of the memory 115 at the time of being downloaded, with the entered keyword as corresponding character information. Although “dictionary function” has not been designated in the “category selection” tag 166, if the user wishes to register the downloaded icon material with the conversion dictionary function, the icon material can be registered with the conversion dictionary function of the memory 115 in association with the entered keyword or a newly entered character, by an operation of the key input unit 114 by the user.

In addition, each time icon material is purchased in this way, the application server 260 determines whether or not the purchased icon material is a personally posted icon material (step S112), and if the purchased icon material is determined to be personally posted icon material, points are given to the poster of the icon material, i.e. the user who posted the icon material (step S113). Specifically, it is determined whether or not the purchased icon material is personally posted icon material, with reference to the “personally posted icon material ID” field of the icon material DB main table 2211 of the icon material DB 221 corresponding to the purchased icon material. If the purchased icon material is determined to be personally posted icon material, the number of points in the “points” field of the personally posted icon material table 2231 of the user DB 223 is incremented (step S112). The number of points to be given to the poster should be determined in advance between the service provider and the user. For example, it is preferable that the number of points to be given reflects the usage fee and the number of usages of the icon material. The earned points can be exchanged for cash or used when a fee-based icon material is purchased. The “points” field is updated at each time a refund is given to the user. In the icon material purchasing processing, if icon material provided to a user is free, no usage fee is charged, but if fee-based icon material is provided to the user, usage fee is charged. The following describes the charge processing carried out by the icon material management system 200.

### <Charge Processing>

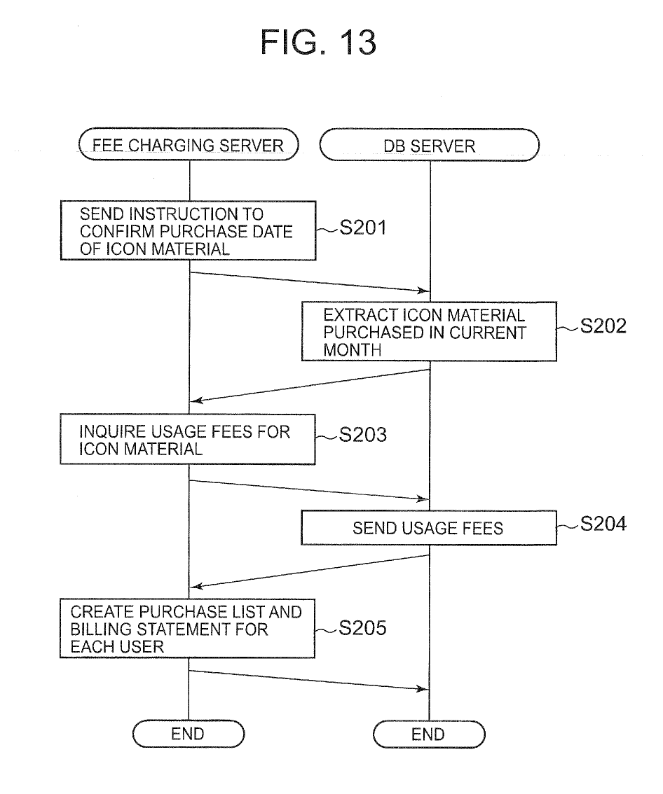

FIG. 13 shows flow of charge processing executed by the fee charging server 240 and the DB server 220. The charge processing is executed when an instruction is inputted from a job stored in the fee charging server 240. It is preferable that the instruction from the job is inputted on a regular basis such as, for example, at the end of each month.

First, the fee charging server 240 sends an instruction to confirm the icon material purchased by users in the current month (step S201). In the DB server 220, the “purchase date” field information is compared with the month when the fee charge processing has been executed (the current month), with reference to the purchased icon material table 2233 of the user DB 223, and corresponding data are extracted (step S202). Next, the fee charging server 240 inquires the DB server220 as to usage fees corresponding to the extracted data (step S203). In the DB server 220, corresponding usage fees are sent to the fee charging server 240 with reference to the “usage fee” field of the icon material DB main table 2211 of the icon material DB 221 (step S204).

Then, based on the data extracted in step S202 and the usage fees sent from the DB server 220 in step S203, the fee charging server 240 creates a purchase list and a billing statement for each user (step S205). The purchase list for each user may be, for example, a list of data made from data for each user ID from among data stored in the purchased icon material table 2233 extracted in step S202. The billing statement for each user may be, for example, a billing statement including lists of purchase and usage fee for each user charged for the icon material purchased by each user in the current month. In addition, it is preferable to inform each user of the number of current points, with reference to “points” field information of the personally posted icon material table 2231 of the user DB 223 in the DB server 220.

As described in the above, in the icon material management system 200 according to the present embodiment, the icon material management server 210 stores and manages icon material data received from the mobile terminal 100, and the application server 260 sends the icon material data stored in the icon material management sever 210 to the mobile terminal 100 in response to a request from the mobile terminal 100. Therefore, the icon material management system 200 according to the present embodiment can manage decorative data created by users as fresh icon material and can provide the icon material for free or for a fee to other users if necessary. Also, as icon material, an animation file, a moving image file, a character, a photograph has been mentioned in the above embodiments, the present invention is not limited thereto. Any form of data including CG (Computer Graphics) data may be applicable as icon material as long as the data may attach decorative information to character information

It should be noted that the description in the present embodiment is only a preferable example of the icon material management system 200 according to the present invention, and the present invention is not limited to such an example. For example, although a cutout moving image has been described as an example of the icon material, various kinds of data can be used as the icon material. This means that, the icon material is not limited to a cutout moving image, but any kind of data or file can be used as long as they can be easily created by a user (creator), uploaded, and easily registered with the conversion dictionary function of a mobile terminal in association with character information. For example, various data such as image data created by CG (Computer Graphics), moving image data or sound data of music may be employed according to embodiments.

Furthermore, in the present embodiment, a mobile phone equipped with a camera has been described as an example of the mobile terminal 100 of a user. However, for example, a mobile communication device, a versatile digital camera, and a personal computer may also be employed as the mobile terminal 100 of a user. As for detailed configuration and detailed operation of the icon material management system 200, modifications within the scope that can realize the object of the present invention are included in the present invention. For example, the icon material management system 200 may be a unified server that includes every function of the icon material management server 210, the user data management server 212, the DB server 220, the icon material checking server 230, the fee charging server 240, the search server 250, and the application server 260.

What is claimed is:

1. A mobile terminal, comprising:
an image capturing unit that captures an image;
an image acquiring unit that continuously drives said image capturing unit and acquires data of a plurality of images;
a decorative data generating unit that generates decorative data based on the data of the plurality of images, the decorative data including image data indicative of an image having only an object common to the plurality of images, nontransparent;
an associating unit that associates the decorative data generated by the decorative data generating unit with character information;
a character input unit that inputs a character from an external operation;
a character information determining unit that determines whether or not character information associated with the decorative data is contained in a text constituted by the character inputted by the character input unit; and
a substituting unit that substitutes and displays the character information with the decorative data associated therewith, if the character information determining unit determines that the character information is included.

2. A mobile terminal as set forth in claim 1, in which
the decorative data includes data of a plurality of continuous images, and, when the decorative data is displayed, the plurality of images are displayed in sequence one after another.

3. A mobile terminal as set forth in claim 1, further comprising a communication unit that sends the text through a wireless communication network to an external device.

4. A mobile terminal as set forth in claim 1, further comprising a communication unit that sends and receives the decorative data associated with the character information through a wireless communication network to an external device.

5. An icon material management system comprising:
a communication unit that communicates with an external device including a mobile terminal as set forth in claim 4;
an icon material data storing unit that stores as icon material data decorative data associated with character information; and
a control unit; wherein
the icon material management system stores the icon material data received from the mobile terminal in the icon material storing unit, and
the control unit sends the icon material data stored in the icon material storing unit to the external device in response to a request from the external device.

6. An icon material management system as set forth in claim 5, further comprising an icon material checking unit that checks whether or not an inappropriate word is contained in the icon material data received from the external device, wherein
the control unit stores in the icon material storing unit the icon material data determined by the icon material checking unit as not containing an inappropriate word.

7. An icon material management system as set forth in claim 5, wherein
the control unit supplies the icon material data contained in the icon material storing unit to the external device after classifying the icon material data in accordance with at least one of storage time, category, and popularity.

8. An icon material management method, comprising:
an icon material storing step of storing decorative data associated with the character information received from the mobile terminal as set forth in claim 4 as icon material data; and
an icon material sending step of sending the icon material data stored in the icon material storing step to the mobile terminal in response to a request from an external device.
